(19) United States
(12) Patent Application Publication
(10) Pub. No.: US 2006/0227547 A1
(43) Pub. Date: Oct. 12, 2006

(54) Light guider structure

(75) Inventor: Wen-Pao Tseng, Yangmei Taoyuan (TW)

Correspondence Address: TROXELL LAW OFFICE PLLC, SUITE 1404, 5205 LEESBURG PIKE, FALLS CHURCH, VA, 22041, US

(73) Assignee: K-Bridge Electronics Co., Ltd.

(21) Appl. No.: 11/099,637

(22) Filed: Apr. 6, 2005

(51) Int. Cl. F21V 9/00

(52) U.S. Cl. 362/231

(57) ABSTRACT

The present invention describes a light guider installed between primary color light emitters of a backlight module and a display panel assembly, which includes a plurality of cones disposed at two or more positions of the light guider for passing through the light of each primary color light emitter, so that the passing light goes through the diffusion and light mixing processes of the cones for at least two times to effectively reduce the area of the wavelength combination of the primary color light emitters.

### BACKGROUND OF THE INVENTION

1. Field of the Invention

The present invention relates to a wavelength combination technology for primary color light emitters of a backlight module, more particularly to a light guider featuring a simple structure, an easy installation, and an effective reduction of the area required by a wavelength combination of primary color light emitters.

2. Description of the Related Art

As a general backlight module primarily combines the wavelength of the lights of three primary color light emitters (such as light emitting diodes): red (R), green (G) and blue (B) to produce a white light effect, the light produced by each primary color light emitter is emitted at an existing angle, and thus it is necessary to diffuse the light of each primary color light emitter 10 by a diffuser 20 for a successful superimposition to combine the wavelengths of the lights of primary color light emitters 10 and achieve a mixed light effect.

Further, when the light of each primary color light emitter 10 passes through a diffuser 20, a single diffuser 10 can only produce a diffusion effect for one time, which will extend the distance of the combination of light waves. In other words, the distance H1 between the light mixing area A and each primary color light emitter 10 is larger. Therefore, there is another prior art that increases the number of diffusers to pass and diffuse the light of each primary color light emitter for several times to shorten the distance of a light wave combination (or reduce the area of light wave combination), so as to lower the costs of related light guide components. However, simply increasing the number of diffusers to shorten the distance of the light wave combination of the primary color light emitters in a practical application is found uneasily to fix the corresponding position of each diffuser, and thus making the installation very complicated. The diffusers have to be stacked with each other, and such arrangement is applicable for low-end applications only.

### SUMMARY OF THE INVENTION

In view of the foregoing shortcomings of the prior art, a light guider structure of the present invention overcomes the shortcomings of the wavelength combination technology of the primary color light emitters of the foregoing backlight module.

Therefore, it is a primary object of the present invention to provide a light guider to be installed between a primary color light emitter of a backlight module and a display panel assembly. The light guider comprises a light incident surface disposed at a position facing the primary color light emitter and a light emitting surface disposed at a position facing the display panel assembly. With the refraction of a reflective mask, the lights of the primary color light emitters emitted from the incident surface into the light guider are refracted for several times before entering the emitting surface of the display panel assembly at a display panel position.

The whole light guider has a plurality of cones disposed on at least two positions for passing the light through the primary color light emitters, such that the passing lights are diffused and mixed by the cones for at least two times to combine the wavelengths of the lights of primary color light emitters, so as to effectively reduce the area of the wavelength combination of the primary color light emitters and facilitate the improvement of the white light quality of the Whole backlight module. Particularly, with the design of several diffusion and light mixing positions on a single light guider, the number of components required for combining the wavelengths of the primary color light emitters of the backlight module is minimized and the assembly technology for related components is simplified.

### BRIEF DESCRIPTION OF THE DRAWINGS

FIG. 1 is a schematic view of a structure of a prior art backlight module that uses a single diffuser to assist the wavelength combination of the primary color light emitters;

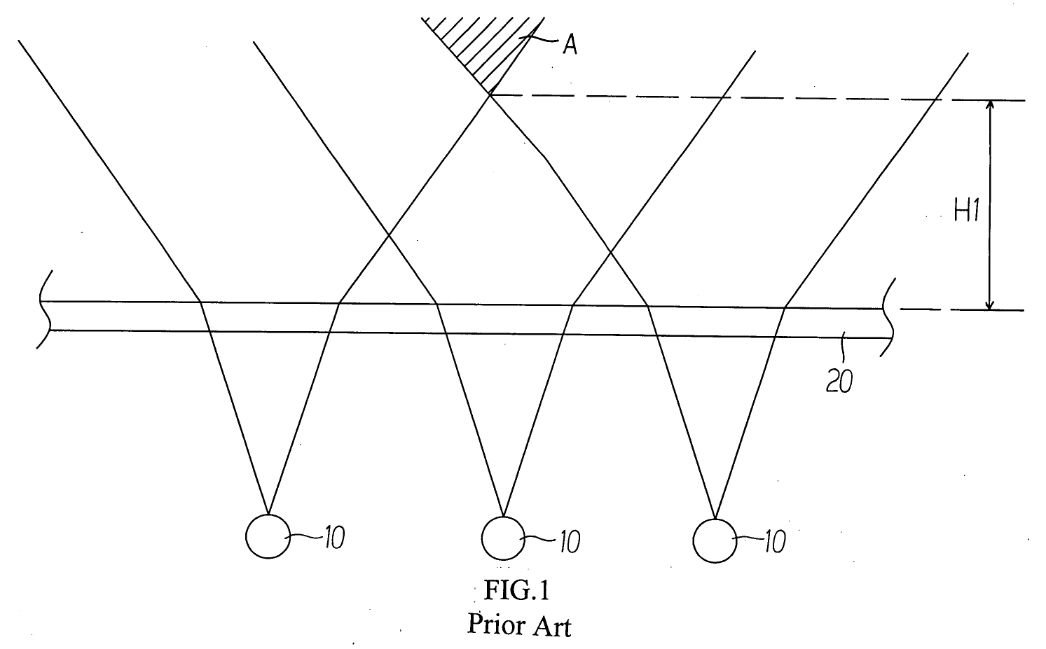

FIG. 2 is a schematic view of an installed light guider in accordance with the present invention;

FIG. 3 is a perspective view of a light guider in accordance with the present invention;

FIG. 4 is a perspective view of another light guider in accordance with the present invention;

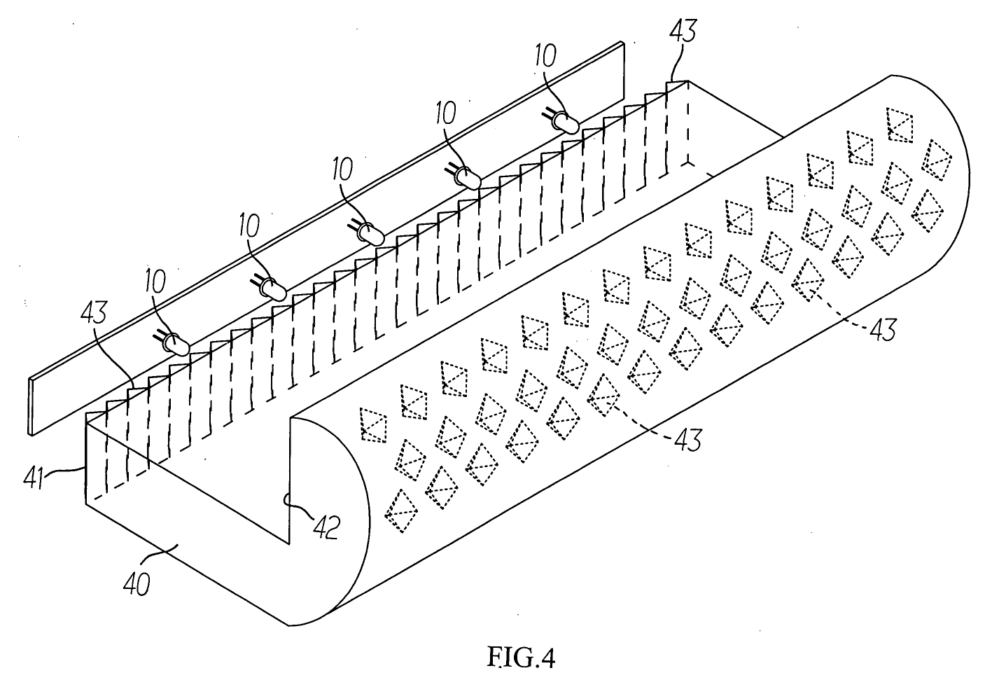

FIG. 5 is a perspective view of a further light guider in accordance with the present invention; and

FIG. 6 is a schematic view of a structure of a backlight module that uses diffusers to assist primary color light emitters to combine the wavelengths of the lights of primary color light emitters.

### DETAILED DESCRIPTION OF THE PREFERRED EMBODIMENTS

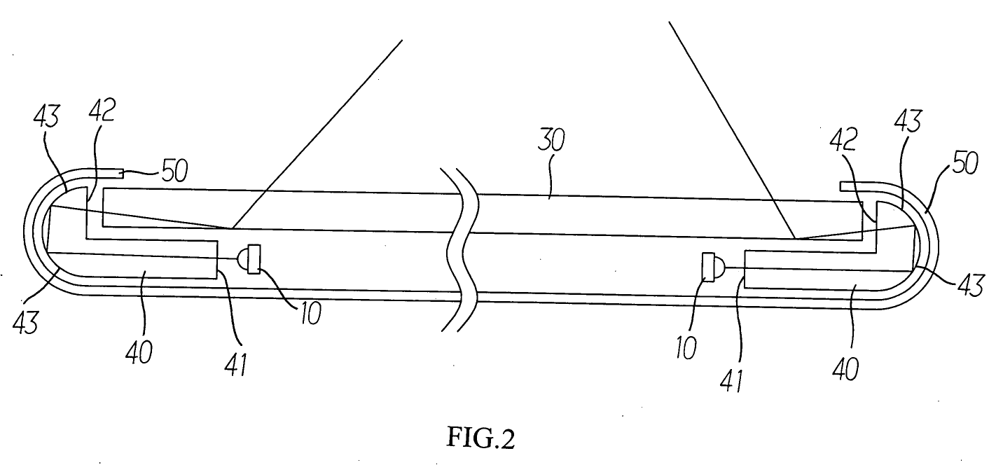

Referring to FIG. 2, the basic structural assembly and the installation of a light guider in accordance with the present invention are illustrated. The light guider is installed between the primary color light emitter 10 of the backlight module and a display panel assembly 30; wherein the light guider 40 has an incident surface 41 disposed at a position facing each primary color light emitter 10 and an emitting surface 42 disposed at a position of the display panel assembly 30 of the backlight module. In this preferred embodiment, the backlight module installs a reflective mask 50 at an end of a panel of the display panel assembly 30 and each primary color light emitter 10 is installed at an area on the internal side of the display panel assembly 30, and the light is projected towards the reflective mask 50.

The emitting surface 42 of the foregoing light guider 40 faces the end position of the panel of the display panel assembly 30, and thus the light of each primary color light emitter 10 is projected from the incident surface 41 into the light guider 40 by the refraction of the reflective mask 50 and entered from the emitting surface 42 into the display panel assembly 30, so as to produce the expected brightness, performance and effect of the whole backlight module.

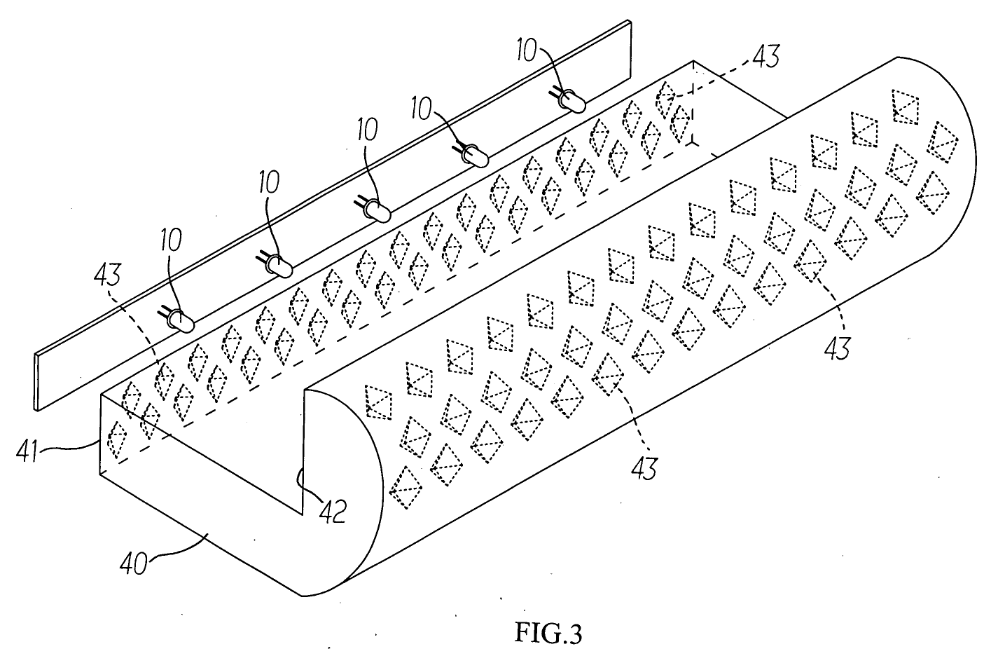

Referring to FIGS. 2 and 3, the whole light guider 40 comprises a plurality of diffusers 43 disposed at two or more positions for passing the light of each primary color light emitter 10 (such as the positions of the incident surface 41 and the emitting surface 42, or the light refraction position of the light guider 40 acted by the reflective mask 40 as shown in the figure). Each diffuser is comprised of a plurality of polyhedral cones as shown in the figure, or a plurality of recessed polyhedral cones (not shown in the figure). The protruded structure of the polyhedral cones or recessed polyhedral cones are integrated to be extended into the installation position of the whole structure or into a structure of different geometric shapes, such as a linear groove, and the passing light can be diffused.

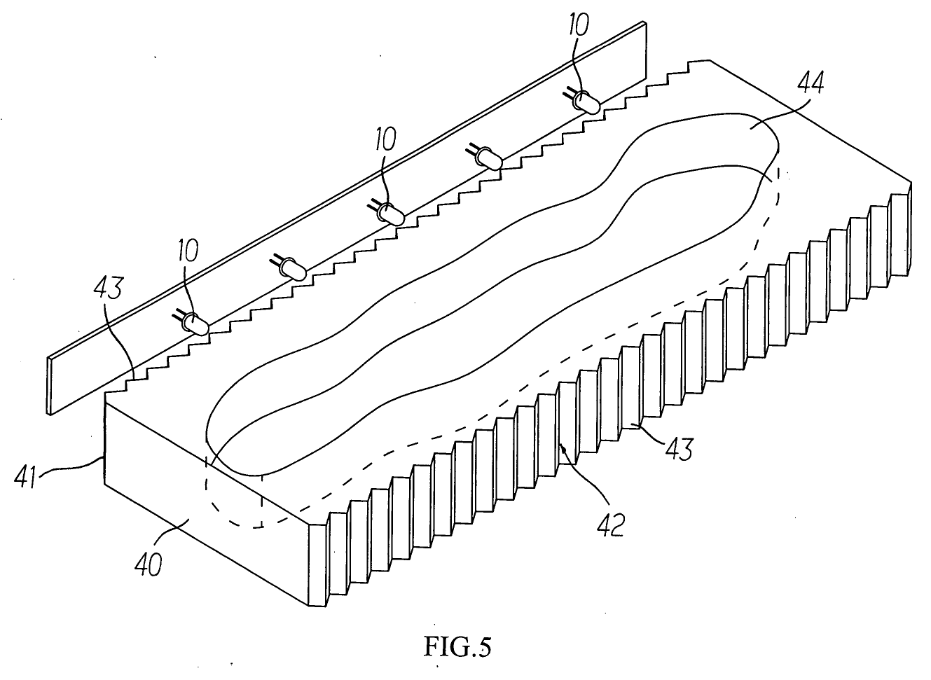

Further, the structure of the light guider 40 is shown in FIG. 5. The light guider 40 has an incident surface 41 disposed at a position facing each primary color light emitter 10 and an emitting surface 42 disposed on another side of the light guider 40. The light of each primary color light emitter 10 is projected from the incident surface 41 to the emitting surface 42 and then passed to the reflective mask 50 and finally refracted to the display panel assembly 30, such that the display panel assembly 30 emits the light evenly. Similarly, the incident surface 41 and the emitting surface 42 install a plurality of diffusers 43 for diffusing the passing light, and the light guider 40 disposed at the internal side comprises a hollow layer 44 to increase the diffusion effect.

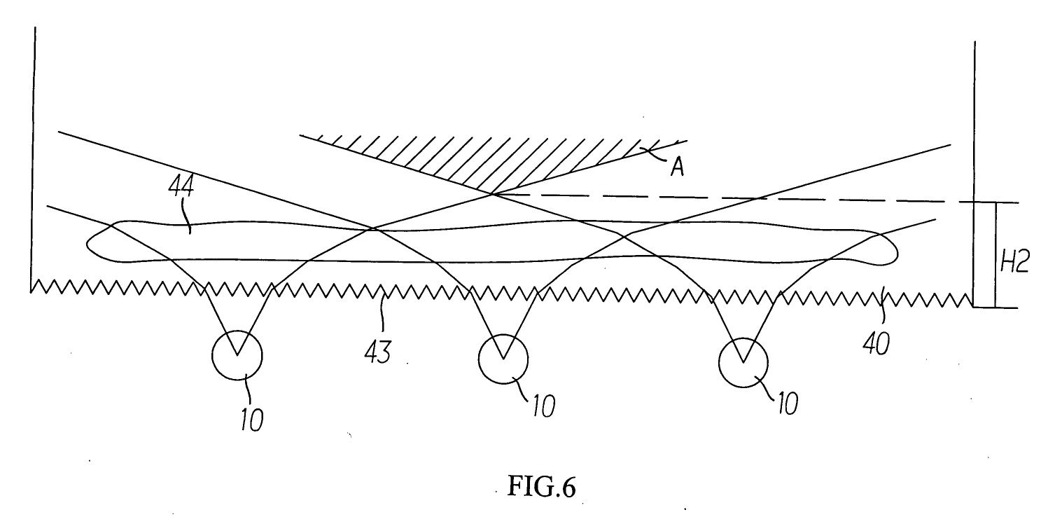

Before the light of each primary color light emitter 10 enters into the display panel assembly 30, the traveling path of the light is shown in FIG. 6. The light passes through the light guider 40 first and the passing light goes through the diffusion and light mixing processes for at least two times under the action of the light guider 40 to combine the wavelengths of the primary color light emitters into a white light, so as to effectively reduce the light mixing area A for combining the wavelengths of the primary color light emitters 10 or shorten the distance H2 from the primary color light emitter and facilitate the improvement of the white light quality of the whole backlight module.

Particularly, a single light guider 10 installs a plurality of diffusion and light mixing positions to reduce the number of components required for the wavelength combination of the primary color light emitters of the backlight module, and simplify the assembling technology of related components.

In summation of the description above, the present provides another preferred feasible light guider structure, which effectively shortens the area required for combining the wavelengths of the primary color light emitters and effectively improves the white light quality of the backlight module and thus fully complies with the patent application requirements. The description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light guider structure, constituting a wavelength combination of lights of primary color light emitters of a backlight module, characterized in that:
said light guider comprises a plurality of diffusers installed at two or more positions for passing through said lights of said primary color light emitters, such that said passing light goes through a diffusion and a light mixing process by said diffusers for at least two times to combine the wavelengths of said lights of said primary color light emitters into a white light, so as to effectively reduce the area of combining the wavelength of said light of said primary color light emitters.

2. The light guider structure of claim 1, wherein said light guider is installed between said primary light color emitters of said backlight module and said display panel assembly, an incident surface is disposed on said light guider at a position facing said primary color light emitters, and an emitting surface disposed at a position facing said display panel assembly.

3. The light guider structure of claim 1, wherein said light guider is installed between said primary color light emitters and said display panel assembly; a reflective mask is installed at an end of a panel of said display panel assembly; said each primary color light emitter is installed at an area on the internal side of said display panel assembly; said light is projected towards said reflective mask; said light guider is installed between said primary color light emitter, said reflective mask and said display panel assembly; an incident surface is disposed on said light guider disposed at a position facing said primary color light emitter and an emitting surface disposed at an end of a panel of said display panel assembly; and said each cone is installed at said incident surface and said emitting surface.

4. The light guider structure of claim 1, wherein said each diffuser is installed on said incident surface, said emitting surface and said light guider at a position with a refraction of said reflective mask.

5. The light guider structure of claim 1, wherein said each diffuser comprises a plurality of polyhedral cones or a plurality of recessed polyhedral cones.

6. The light guider structure of claim 1, wherein said each diffuser is comprised of integrally extended polyhedral cones, recessed polyhedral cones, or linear grooves.

7. The light guider structure of claim 1, wherein said each light guider further comprises a hollow layer therein.
